(19) United States
(12) Patent Application Publication
(10) Pub. No.: US 2006/0255721 A1
(43) Pub. Date: Nov. 16, 2006

(54) Organic electroluminescent device

(75) Inventors: Tatsuya Igarashi, Kanagawa (JP); Jiro Tsukahara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/410,019

(22) Filed: Apr. 25, 2006

(30) Foreign Application Priority Data
Apr. 25, 2005 (JP) 2005-127028

(51) Int. Cl. H01J 1/62; H01J 63/04; C07F 15/00

(52) U.S. Cl. 313/504; 546/2

(57) ABSTRACT

The present invention provides an organic electroluminescent device comprising one or more organic compound layers including a luminescent layer between a pair of electrodes, wherein at least one of the organic compound layers contains a pentadentate or hexadentate metal complex having a bivalent platinum ion or a bivalent palladium ion as the central metal ion.

### CROSS-REFERENCE TO RELATED APPLICATION

This invention claims priority under 35 USC 119 from Japanese Patent Application Nos.2005-127028, the disclosure of which is incorporated by reference herein.

### BACKGROUND OF THE INVENTION

1. Field of the Invention

The present invention relates to an organic electroluminescent device (hereunder, also called “luminescent device” or “organic EL device”) which can convert electric energy into light and emit the light.

2. Description of the Related Art

An organic electroluminescent (EL) device has been drawing attention as a promising display device, since it can emit high intensity light at low voltage. The important characteristic value of this organic electroluminescent device includes the external quantum efficiency. The external quantum efficiency is calculated by the following equation:
External quantum efficiency φ=number of photons emitted from device/number of electrons injected into device.
As the value becomes greater, the device can be said to be more advantageous from the point of power consumption.

The external quantum efficiency of the organic electroluminescent device is determined specifically according to the following equation:
External quantum efficiency φ=internal quantum efficiency×light extraction efficiency.

In an organic EL device utilizing fluorescent emission from organic compounds, the upper limit of internal quantum efficiency is 25%. Since the light extraction efficiency is about 20%, the upper limit of external quantum efficiency is estimated to be about 5%.

As a method of improving the internal quantum efficiency of an organic electroluminescent device and of improving the external quantum efficiency of the device, there is reported a device utilizing a triplet luminescent material (phosphorescence material), which comprises a platinum complex (U.S. Pat. No. 6,303,238B1 and U.S. Pat. No. 6,653,654B1). The device described in these documents is capable of improving the external quantum efficiency, compared to a conventional device (singlet luminescent device) utilizing fluorescent emission. However, the luminescence is limited to orange to red light emission. Therefore, in a case of considering full color usage, there is a problem from the point of shortening the emission wavelength. Moreover, improvements have been also desired from the point of drive durability and luminous efficiency.

Furthermore, in Patent Document (International Publication No. 2004/039781 pamphlet), there is reported a luminescent device containing a platinum complex which has a dipyridylbenzene ligand. The device described in the document achieves high efficiency, however improvements have been desired from the point of durability.

### SUMMARY OF THE INVENTION

The present invention has been made in view of the above circumstances and provides an organic electroluminescent device.

A first aspect of the present invention provides an organic electroluminescent device comprising one or more organic compound layers including a luminescent layer between a pair of electrodes, wherein at least one of the organic compound layers contains a pentadentate or hexadentate metal complex having a bivalent platinum ion or a bivalent palladium ion as the central metal ion.

A second aspect of the present invention provides an organic electroluminescent device comprising one or more organic compound layers including a luminescent layer between a pair of electrodes, wherein at least one of the organic compound layers contains a compound which is a pentadentate or hexadentate metal complex having a bivalent platinum ion or a bivalent palladium ion as the central metal ion, and having a pentadentate or hexadentate ligand, and is represented by the following formula (1), formula (2), or formula (3):

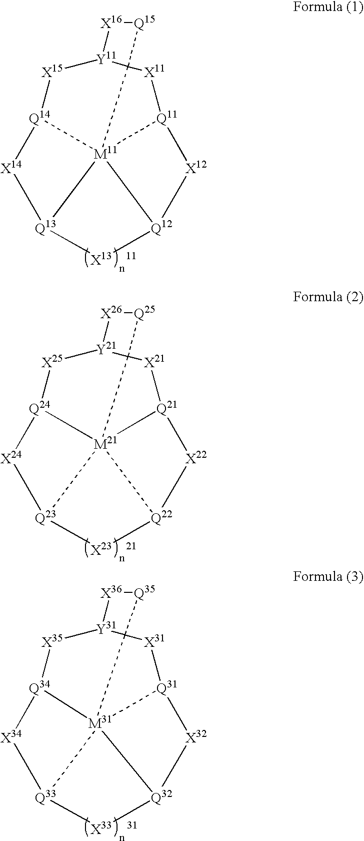

wherein in the formula (1), X¹¹ to X¹⁶ independently represent a single bond or a linking group; Q¹¹ to Q¹⁵ represent an atom group coordinated to M¹¹; Y¹¹ represents a linking group; n¹¹ represents 0 or 1; if n¹¹ is 0, there is no bond between Q¹² and Q¹³ via X¹³; M¹¹ represents a bivalent platinum ion or a bivalent palladium ion;

wherein in the formula (2), X¹¹ to X²⁶ independently represent a single bond or a linking group; Q²¹ to Q²⁵ represent an atom group coordinated to M²¹; Y²¹ represents a linking group; n²¹ represents 0 or 1; if n²¹ is 0, there is no bond between Q²² and Q²³ via X²³; M²¹ represents a bivalent platinum ion or a bivalent palladium ion;

wherein in the formula (3), X³¹ to X³⁶ independently represent a single bond or a linking group; Q³¹ to Q³⁵ represent an atom group coordinated to M³¹; Y³¹ represents a linking group; n³¹ represents 0 or 1; if n³¹ is 0, there is no bond between Q³² and Q³³ via X³³; M³¹ represents a bivalent platinum ion or a bivalent palladium ion.

### DETAILED DESCRIPTION OF THE INVENTION

Hereunder is a detailed description of the present invention.

The organic electroluminescent device of the present invention is an organic electroluminescent device comprising one or more organic compound layers including a luminescent layer between a pair of electrodes, wherein at least one of the organic compound layers contains a pentadentate or hexadentate metal complex having a bivalent platinum ion or a bivalent palladium ion as the central metal ion.

Having the above structure, the organic electroluminescent device can be superior in at least either high luminous efficiency or drive durability. Furthermore, by containing a compound having a specific structure in the organic compound layer, the organic electroluminescent device of the present invention can be suitably used for a device having a short emission wavelength.

(Pentadentate or hexadentate metal complex having a bivalent platinum ion or a bivalent palladium ion as a central metal ion)

Hereunder is a description of a pentadentate or hexadentate metal complex having a bivalent platinum ion or a bivalent palladium ion as the central metal ion, serving as the characteristic component in the present invention.

In the present invention, the pentadentate or hexadentate metal complex is required to be contained in one or more organic compound layers, and is preferably contained as a phosphorescence material in the luminescent layer.

Here, the pentadentate metal complex means a complex wherein five atoms in the ligand(s) are coordinated to the central metal ion. Moreover, the hexadentate metal complex means a complex wherein six atoms in the ligand(s) are coordinated to the central metal ion.

The central metal ion of the pentadentate or hexadentate metal complex in the present invention is a bivalent platinum ion or a bivalent palladium ion, and more preferably a bivalent platinum ion.

Moreover, in the present invention, the hexadentate metal complex is preferred.

The platinum complex typically represented by a platinum porphyrin complex used as a phosphorescence material of an organic electroluminescent device is a tetradentate complex having a tetradentate ligand porphyrin.

On the other hand, regarding the pentadentate or hexadentate metal complex in the present invention, for example if mentioning about a case where the complex is a platinum complex, since the reactive platinum apical position can be blocked with a ligand, there is an advantage from the point of stability. Furthermore, by coordinating a ligand having a strong ligand field to the apical position, it becomes possible to achieve shortening of the wavelength of luminescence.

The ligand of the pentadentate or hexadentate metal complex in the present invention may be either a monodentate ligand or a multidentate ligand,which is a bidentate or higher dentate ligand.

The pentadentate metal complex in the present invention preferably has a ligand having two or more positions, more preferably a ligand having three or more positions, still more preferably a ligand having four or more positions, and particularly preferably a ligand having five positions.

Moreover, as to the ligand, the pentadentate metal complex of the present invention may have a form having a bidentate ligand and a tridentate ligand, and a form having a pentadentate ligand. The form having a pentadentate ligand is more preferred.

The hexadentate metal complex in the present invention preferably has a ligand having two or more positions, more preferably a ligand having three or more positions, still more preferably a ligand having four or more positions, and particularly preferably a ligand having six positions.

Moreover, as to the ligand, the hexadentate metal complex of the present invention may have a form having two tridentate ligands (the tridentate ligands may be the same or different), a form having a tetradentate ligand and a bidentate ligand, and a form having a hexadentate ligand. The form having two tridentate ligands and the form having a hexadentate ligand are more preferred. The form having a hexadentate ligand is still more preferred.

In the present invention, the pentadentate metal complex having a pentadentate ligand is preferably a compound represented by the following formula (1), formula (2), or formula (3), more preferably a compound represented by the formula (1) or formula (2), and still more preferably a compound represented by the formula (1).

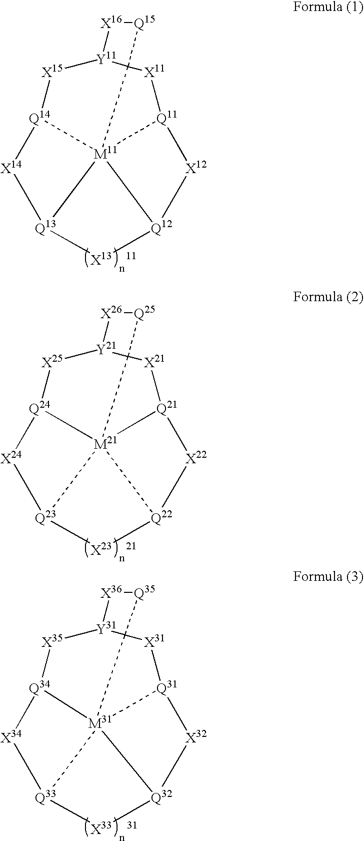

In the formula (1), X¹¹ to X¹⁶ independently represent a single bond or a linking group. Q¹¹ to Q¹⁵ represent an atom group coordinated to M¹¹. Y¹¹ represents a linking group. n¹¹ represents 0 or 1. If n¹¹ is 0, there is no bond between Q¹² and Q¹³ via X¹³. M¹¹ represents a bivalent platinum ion or a bivalent palladium ion.

In the formula (2), X²¹ to X²⁶ independently represent a single bond or a linking group. Q²¹ to Q²⁵ represent an atom group coordinated to M²¹. Y²¹ represents a linking group. n²¹ represents 0 or 1. If n²¹ is 0, there is no bond between Q²² and Q²³ via X²³. M²¹ represents a bivalent platinum ion or a bivalent palladium ion.

In the formula (3), X³¹ to X³⁶ independently represent a single bond or a linking group. Q³¹ to Q³⁵ represent an atom group coordinated to M³¹. Y³¹ represents a linking group. n³¹ represents 0 or 1. If n³¹ is 0, there is no bond between Q³² and Q³³ via X³³. M³¹ represents a bivalent platinum ion or a bivalent palladium ion.

The compound represented by the formula (1) is described. X¹¹ to X¹⁶ independently represent a single bond or a linking group.

The linking group represented by X¹¹ to X¹⁶ is not specifically limited. However, examples thereof include an alkylene group (such as a methylene group, a dimethylmethylene group, a diisopropylmethylene group, a diphenylmethylene group, an ethylene group, and a tetramethylethylene group), an alkenylene group (such as a vinylene group and a dimethylvinylene group), an alkynylene group (such as an ethynylene group), an arylene group (such as a phenylene group and a naphthylene group), a heteroarylene group (such as a pyridylene group, a pyrazylene group, and a quinolylene group), an oxygen linking group, a sulfur linking group, a nitrogen linking group (such as a methylamino linking group, a phenylamino linking group, and a t-butylamino linking group), and linking groups in combination thereof (such as an oxirenemethylene group).

X¹¹, X¹², X¹⁴, and X¹⁵ are preferably a single bond or an alkylene group, and more preferably a single bond. X¹³ and X¹⁶ are preferably a single bond or an alkylene group, and more preferably an alkylene bond.

Q¹¹ to Q¹⁵ represent an atom group coordinated to M¹¹. The atom group is not specifically limited insofar as it is an atom group coordinated to M¹¹. However, an atom group coordinated with a carbon atom, an atom group coordinated with a nitrogen atom, an atom group coordinated with an oxygen atom, an atom group coordinated with a sulfur atom, and an atom group coordinated with a phosphorus atom are preferred. An atom group coordinated with a carbon atom, an atom group coordinated with a nitrogen atom, and an atom group coordinated with an oxygen atom are more preferred. An atom group coordinated with a carbon atom, and an atom group coordinated with a nitrogen atom are still more preferred.

Examples of the atom group coordinated with a carbon atom include an imino group, an aromatic hydrocarbon cyclic group (such as benzene and naphthalene), a heterocyclic group (such as thiophene, pyridine, pyrazine, pyrimidine, pyridazine, triazine, thiazole, oxazole, pyrrole, imidazole, pyrazole, and triazole), condensed rings including them, and tautomers thereof. These groups may have further substituents. Examples of the introducible substituents include groups represented by R⁷⁰¹ in the formula (7) described later.

Examples of the atom group coordinated with a nitrogen atom include a nitrogen-containing heterocyclic group (such as pyridine, pyrazine, pyrimidine, pyridazine, triazine, thiazole, oxazole, pyrrole, imidazole, pyrazole, and triazole), an amino group (an alkylamino group (preferably having 2 to 30 carbon atoms, more preferably having 2 to 20 carbon atoms, and particularly preferably having 2 to 10 carbon atoms, such as methylamino), and an arylamino group (such as phenylamino)), an acylamino group (preferably having 2 to 30 carbon atoms, more preferably having 2 to 20 carbon atoms, and particularly preferably having 2 to 10 carbon atoms, such as acetylamino and benzoylamino), an alkoxycarbonylamino group (preferably having 2 to 30 carbon atoms, more preferably having 2 to 20 carbon atoms, and particularly preferably having 2 to 12 carbon atoms, such as methoxycarbonylamino), an aryloxycarbonylamino group (preferably having 7 to 30 carbon atoms, more preferably having 7 to 20 carbon atoms, and particularly preferably having 7 to 12 carbon atoms, such as phenyloxycarbonylamino), a sulfonylamino group (preferably having 1 to 30 carbon atoms, more preferably having 1 to 20 carbon atoms, and particularly preferably having 1 to 12 carbon atoms, such as methanesulfonylamino and benzene sulfonylamino), and an imino group. These groups may be further substituted. Examples of the introducible substituents include groups represented by R⁷⁰¹ in the formula (7) described later.

Examples of the atom group coordinated with an oxygen atom include an alkoxy group (preferably having 1 to 30 carbon atoms, more preferably having 1 to 20 carbon atoms, and particularly preferably having 1 to 10 carbon atoms, such as methoxy, ethoxy, butoxy, and 2-ethylhexyloxy), an aryloxy group (preferably having 6 to 30 carbon atoms, more preferably having 6 to 20 carbon atoms, and particularly preferably having 6 to 12 carbon atoms, such as phenyloxy, 1-naphthyloxy, and 2-naphthyloxy), a heterocyclicoxy group (preferably having 1 to 30 carbon atoms, more preferably having 1 to 20 carbon atoms, and particularly preferably having 1 to 12 carbon atoms, such as pyridyloxy, pyrazyloxy, pyrimidyloxy, and quinolyloxy), an acyloxy group (preferably having 2 to 30 carbon atoms, more preferably having 2 to 20 carbon atoms, and particularly preferably having 2 to 10 carbon atoms, such as acetoxy and benzoyloxy), a silyloxy group (preferably having 3 to 40 carbon atoms, more preferably having 3 to 30 carbon atoms, and particularly preferably having 3 to 24 carbon atoms, such as trimethylsilyloxy and triphenylsilyloxy), a carbonyl group (such as a ketone group, an ester group, and an amide group), and an ether group (such as a dialkylether group, a diarylether group, and a furyl group). These groups may be further substituted. Examples of the introducible substituents include groups represented by R⁷⁰¹ in the formula (7) described later.

Examples of the atom group coordinated with a sulfur atom include an alkylthio group (preferably having 1 to 30 carbon atoms, more preferably having 1 to 20 carbon atoms, and particularly preferably having 1 to 12 carbon atoms, such as methylthio and ethylthio), an arylthio group (preferably having 6 to 30 carbon atoms, more preferably having 6 to 20 carbon atoms, and particularly preferably having 6 to 12 carbon atoms, such as phenylthio), a heterocyclicthio group (preferably having 1 to 30 carbon atoms, more preferably having 1 to 20 carbon atoms, and particularly preferably having 1 to 12 carbon atoms, such as pyridylthio, 2-benzimizolylthio, 2-benzoxazolylthio, and 2-benzothiazolylthio), a thiocarbonyl group (such as a thioketone group and a thioester group), and a thioether group (such as a dialkylthio ether group, a diarylthio ether group, and a thiofuryl group). These groups may be further substituted. Examples of the introducible substituents include groups represented by R⁷⁰¹ in the formula (7) described later.

Examples of the atom group coordinated with a phosphorus atom include a dialkylphosphino group, a diarylphosphino group, trialkylphosphine, triarylphosphine, and phosphinine groups. These groups may be further substituted. Examples of the introducible substituents include groups represented by R⁷⁰¹ in the formula (7) described later.

Q¹¹ and Q¹⁴ are preferably an atom group coordinated with a nitrogen atom and an atom group coordinated with a phosphorus atom, more preferably an atom group coordinated with a nitrogen atom, still more preferably, a nitrogen-containing heterocyclic group coordinated with a nitrogen atom, and particularly preferably a single ring of nitrogen-containing heterocyclic group coordinated with a nitrogen atom.

Q¹² and Q¹³ are preferably an atom group coordinated with a carbon atom, an atom group coordinated with a nitrogen atom, and an atom group coordinated with an oxygen atom, more preferably an aryl group coordinated with a carbon atom, a heteroaryl group coordinated with a carbon atom, a heteroaryl group coordinated with a nitrogen atom, a carboxyl group coordinated with an oxygen atom, an aryloxy group coordinated with an oxygen atom, and a heteroaryloxy group coordinated with an oxygen atom, still more preferably an aryl group coordinated with a carbon atom, a heteroaryl group coordinated with a nitrogen atom, and a carboxyl group coordinated with an oxygen atom, and particularly preferably an aryl group coordinated with a carbon atom.

Y¹¹ represents a linking group. The linking group is not specifically limited. However, a nitrogen linking group, a carbon linking group (examples of the substituents in the carbon linking group include groups represented by R⁷⁰¹ in the formula (7) described later), and a silicon linking group (examples of the substituents in the silicon linking group include groups represented by R⁷⁰¹ in the formula (7) described later) are preferred. A carbon linking group and a silicon linking group are more preferred. A carbon linking group is still more preferred.

n¹¹ represents 0 or 1, and 0 is preferred. If n¹¹ is 0, there is no bond between Q¹² and Q¹³ via X¹³.

M¹¹ represents a bivalent platinum ion or a bivalent palladium ion. A bivalent palladium ion is more preferred.

The compound represented by the formula (2) is described.

X²¹ to X²⁶ are respectively synonymous with X¹¹ to X¹⁶ in the formula (1), and the preferred range is also the same.

Q²¹ to Q²⁵ represent an atom group coordinated to M²¹. The atom group is not specifically limited insofar as it is an atom group coordinated to M²¹. However, an atom group coordinated with a carbon atom, an atom group coordinated with a nitrogen atom, an atom group coordinated with an oxygen atom, an atom group coordinated with a sulfur atom, and an atom group coordinated with a phosphorus atom are preferred. An atom group coordinated with a carbon atom, an atom group coordinated with a nitrogen atom, and an atom group coordinated with an oxygen atom are more preferred. An atom group coordinated with a carbon atom and an atom group coordinated with a nitrogen atom are still more preferred.

Q²¹ and Q²⁴ are preferably an atom group coordinated with a carbon atom and an atom group coordinated with a nitrogen atom, more preferably an aryl group coordinated with a carbon atom, a heteroaryl group coordinated with a carbon atom, and a heteroaryl group coordinated with a nitrogen atom, still more preferably an aryl group coordinated with a carbon atom and a heteroaryl group coordinated with a nitrogen atom, and particularly preferably an aryl group coordinated with a carbon atom.

Q²² and Q²³ are preferably an atom group coordinated with a nitrogen atom and an atom group coordinated with a phosphorus atom, more preferably an atom group coordinated with a nitrogen atom, still more preferably, a nitrogen-containing heterocyclic group coordinated with a nitrogen atom, and particularly preferably a single ring of nitrogen-containing heterocyclic group coordinated with a nitrogen atom.

Y²¹ is synonymous with Y¹¹ in the formula (1), and the preferred range is also the same.

n²¹ represents 0 or 1, and 0 is preferred. If n²¹ is 0, there is no bond between Q²² and Q²³ via X²³.

M²¹ is synonymous with M¹¹ in the formula (1), and the preferred range is also the same.

The compound represented by the formula (3) is described.

X³¹ to X³⁶ are respectively synonymous with X¹¹ to X¹⁶ in the formula (1), and the preferred range is also the same.

Q³¹ to Q³⁵ represent an atom group coordinated to M²¹. The atom group is not specifically limited insofar as it is an atom group coordinated to M²¹. However, an atom group coordinated with a carbon atom, an atom group coordinated with a nitrogen atom, an atom group coordinated with an oxygen atom, an atom group coordinated with a sulfur atom, and an atom group coordinated with a phosphorus atom are preferred. An atom group coordinated with a carbon atom, an atom group coordinated with a nitrogen atom, and an atom group coordinated with an oxygen atom are more preferred. An atom group coordinated with a carbon atom and an atom group coordinated with a nitrogen atom are still more preferred.

Q³¹ and Q³³ are preferably an atom group coordinated with a nitrogen atom and an atom group coordinated with a phosphorus atom, more preferably an atom group coordinated with a nitrogen atom, still more preferably, a nitrogen-containing heterocyclic group coordinated with a nitrogen atom, and particularly preferably a single ring of nitrogen-containing heterocyclic group coordinated with a nitrogen atom.

Q³² is preferably an atom group coordinated with a carbon atom, an atom group coordinated with a nitrogen atom, and an atom group coordinated with an oxygen atom, more preferably an aryl group coordinated with a carbon atom, a heteroaryl group coordinated with a carbon atom, a heteroaryl group coordinated with a nitrogen atom, a carboxyl group coordinated with an oxygen atom, an aryloxy group coordinated with an oxygen atom, and a heteroaryloxy group coordinated with an oxygen atom, still more preferably an aryl group coordinated with a carbon atom, a heteroaryl group coordinated with a nitrogen atom, and a carboxyl group coordinated with an oxygen atom, and particularly preferably an aryl group coordinated with a carbon atom.

Q³⁴ is preferably an atom group coordinated with a carbon atom, and an atom group coordinated with a nitrogen atom, more preferably an aryl group coordinated with a carbon atom, a heteroaryl group coordinated with a carbon atom, and a heteroaryl group coordinated with a nitrogen atom, still more preferably an aryl group coordinated with a carbon atom and a heteroaryl group coordinated with a nitrogen atom, and particularly preferably an aryl group coordinated with a carbon atom.

Y³¹ is synonymous with Y¹¹ in the formula (1), and the preferred range is also the same.

n³¹ represents 0 or 1, and 0 is preferred. If n³¹ is 0, there is no bond between Q³² and Q³³ via X³³.

M³¹ is synonymous with Ml in the formula (1), and the preferred range is also the same.

In the present invention, the hexadentate metal complex having a hexadentate ligand is preferably a compound represented by the following formula (4), formula (5), or formula (6), more preferably a compound represented by the formula (4) or formula (5), and still more preferably a compound represented by the formula (4).

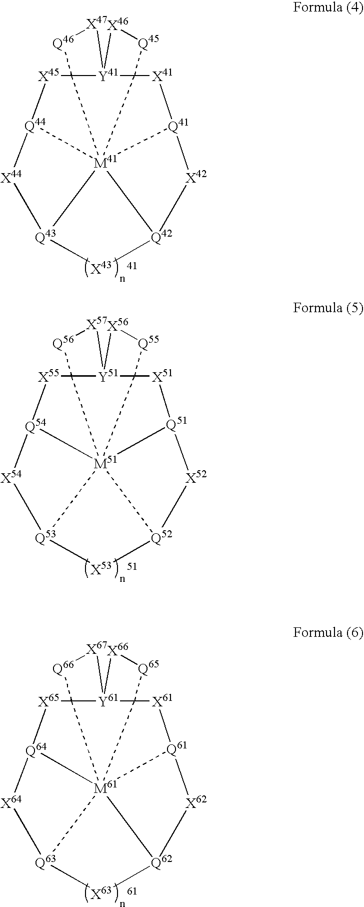

In the formula (4), X⁴¹ to X⁴⁷ independently represent a single bond or a linking group. Q⁴¹ to Q⁴⁶ represent an atom group coordinated to M⁴¹. Y⁴¹ represents a carbon atom or a silicon atom. n⁴¹ represents 0 or 1. If n⁴¹ is 0, there is no bond between Q⁴² and Q⁴³ via X⁴³. M⁴¹ represents a bivalent platinum ion or a bivalent palladium ion.

In the formula (5), X⁵¹ to X⁵⁷ independently represent a single bond or a linking group. Q⁵¹ to Q⁵⁶ represent an atom group coordinated to M⁵¹. Y⁵¹ represents a carbon atom or a silicon atom. n⁵¹ represents 0 or 1. If n⁵¹ is 0, there is no bond between Q⁵² and Q⁵³ via X⁵³. M⁵¹ represents a bivalent platinum ion or a bivalent palladium ion.

In the formula (6), X⁶¹ to X⁶⁷ independently represent a single bond or a linking group. Q⁶¹ to Q⁶⁶ represent an atom group coordinated to M⁶¹. Y⁶¹ represents a carbon atom or a silicon atom. n⁶¹ represents 0 or 1. If n⁶¹ is 0, there is no bond between Q⁶² and Q⁶³ via X^{63.} M⁶¹ represents a bivalent platinum ion or a bivalent palladium ion.

The compound represented by the formula (4) is described.

X⁴¹ to X⁴⁶ are respectively synonymous with X¹¹ to X¹⁶ in the formula (1), and the preferred range is also the same. X⁴⁷ is synonymous with X¹⁶ in the formula (1), and the preferred range is also the same.

Q⁴¹ to Q⁴⁶ are respectively synonymous with Q¹¹ to Q¹⁶ in the formula (1), and the preferred range is also the same. Q⁴⁷ is synonymous with Q¹⁵ in the formula (1), and the preferred range is also the same.

Y⁴¹ represents a carbon atom or a silicon atom, and a carbon atom is preferred.

n⁴¹ represents 0 or 1, and 0 is preferred. If n⁴¹ is 0, there is no bond between Q⁴² and Q⁴³ via X⁴³.

M⁴¹ represents a bivalent platinum ion or a bivalent palladium ion, and a bivalent palladium ion is more preferred.

The compound represented by the formula (5) is described.

X⁵¹ to X⁵⁶ are respectively synonymous with X¹¹ to X¹⁶ in the formula (1), and the preferred range is also the same. X⁵⁷ is synonymous with X¹⁶ in the formula (1), and the preferred range is also the same.

Q⁵¹ to Q⁵⁵ are respectively synonymous with Q²¹ to Q²⁵ in the formula (2), and the preferred range is also the same. Q⁵⁶ is synonymous with Q²⁵ in the formula (2), and the preferred range is also the same.

Y⁵¹ is synonymous with Y⁴¹ in the formula (4), and the preferred range is also the same.

n⁵¹ represents 0 or 1, and 0 is preferred. If n⁵¹ is 0, there is no bond between Q⁵² and Q⁵³ via X⁵³.

M⁵¹ is synonymous with M⁴¹ in the formula (4), and the preferred range is also the same.

The compound represented by the formula (6) is described.

X⁶¹ to X⁶⁶ are respectively synonymous with X¹¹ to X¹⁶ in the formula (1), and the preferred range is also the same. X⁶⁷ is synonymous with X¹⁶ in the formula (1), and the preferred range is also the same.

Q⁶¹ to Q⁶⁵ are respectively synonymous with Q³¹ to Q³⁵ in the formula (3), and the preferred range is also the same. Q⁶⁶ is synonymous with Q³⁵ in the formula (3), and the preferred range is also the same.

Y⁶¹ is synonymous with Y⁴¹ in the formula (4), and the preferred range is also the same.

n⁶¹ represents 0 or 1, and 0 is preferred. If n⁶¹ is 0, there is no bond between Q⁶¹ and Q⁶³ via X⁶³.

M⁶¹ is synonymous with M⁴¹ in the formula (4), and the preferred range is also the same.

The compound represented by the formula (1) is preferably a compound represented by the following formula (7).

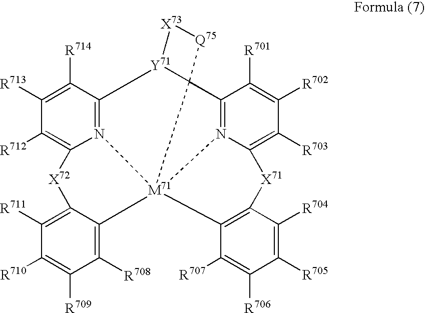

In the formula (7), X⁷¹ to X⁷³ independently represent a single bond or a linking group. Q⁷⁵ represents an atom group coordinated to M⁷¹. Y⁷¹ represents a linking group. R⁷⁰¹ to R⁷¹⁴ independently represent a hydrogen atom or a substituent. R⁷⁰⁷ and R⁷⁰⁸ may be bonded. M⁷¹ represents a bivalent platinum ion or a bivalent palladium ion.

Moreover, the compound represented by the formula (4) is preferably a compound represented by the following formula (8).

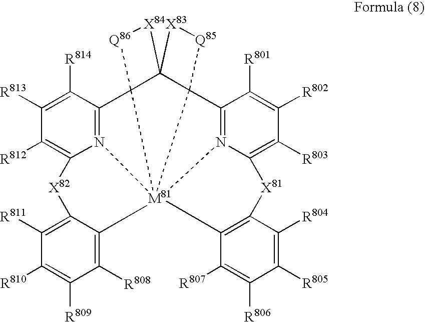

In the formula (8), X⁸¹ to X⁸⁴ independently represent a single bond or a linking group. Q⁸⁵ and Q⁸⁶ represent an atom group coordinated to M⁸¹. R⁸⁰¹ to R⁸¹⁴ independently represent a hydrogen atom or a substituent. R⁸⁰⁷ and R⁸⁰⁸ may be bonded. M⁸¹ represents a bivalent platinum ion or a bivalent palladium ion.

The compound represented by the formula (7) is described.

X⁷¹, X⁷³, Q⁷⁵, and Y⁷¹ are respectively synonymous with X¹², X¹⁴, Q¹⁵, and Y¹¹ in the formula (1), and the preferred range is also the same.

R⁷⁰¹ to R⁷¹⁴ independently represent a hydrogen atom or a substituent. R⁷⁰⁷ and R⁷⁰⁸ may be bonded.

Examples of the substituents represented by R⁷⁰¹ to R⁷¹⁴ include an alkyl group (preferably having 1 to 30 carbon atoms, more preferably having 1 to 20 carbon atoms, and particularly preferably having 1 to 10 carbon atoms, such as methyl, ethyl, iso-propyl, tert-butyl, n-octyl, n-decyl, n-hexadecyl, cyclopropyl, cyclopentyl, and cyclohexyl), an alkenyl group (preferably having 2 to 30 carbon atoms, more preferably having 2 to 20 carbon atoms, and particularly preferably having 2 to 10 carbon atoms, such as vinyl, allyl, 2-butenyl, and 3-pentenyl), an alkynyl group (preferably having 2 to 30 carbon atoms, more preferably having 2 to 20 carbon atoms, and particularly preferably having 2 to 10 carbon atoms, such as propargyl and 3-pentynyl), an aryl group (preferably having 6 to 30 carbon atoms, more preferably having 6 to 20 carbon atoms, and particularly preferably having 6 to 12 carbon atoms, such as phenyl, p-methylphenyl, naphthyl, and anthranil), an amino group (preferably having 0 to 30 carbon atoms, more preferably having 0 to 20 carbon atoms, and particularly preferably having 0 to 10 carbon atoms, such as amino, methylamino, dimethylamino, diethylamino, dibenzylamino, diphenylamino, and ditolylamino), an alkoxy group (preferably having 1 to 30 carbon atoms, more preferably having 1 to 20 carbon atoms, and particularly preferably having 1 to 10 carbon atoms, such as methoxy, ethoxy, butoxy, and 2-ethylhexyloxy), an aryloxy group (preferably having 6 to 30 carbon atoms, more preferably having 6 to 20 carbon atoms, and particularly preferably having 6 to 12 carbon atoms, such as phenyloxy, 1-naphthyloxy, and 2-naphthyloxy), a heterocyclicoxy group (preferably having 1 to 30 carbon atoms, more preferably having 1 to 20 carbon atoms, and particularly preferably having 1 to 12 carbon atoms, such as pyridyloxy, pyrazyloxy, pyrimidyloxy, and quinolyloxy), and an acyl group (preferably having 1 to 30 carbon atoms, more preferably having 1 to 20 carbon atoms, and particularly preferably having 1 to 12 carbon atoms, such as acetyl, benzoyl, formyl, and pivaloyl),

an alkoxycarbonyl group (preferably having 2 to 30 carbon atoms, more preferably having 2 to 20 carbon atoms, and particularly preferably having 2 to 12 carbon atoms, such as methoxycarbonyl and ethoxycarbonyl), an aryloxycarbonyl group (preferably having 7 to 30 carbon atoms, more preferably having 7 to 20 carbon atoms, and particularly preferably having 7 to 12 carbon atoms, such as phenyloxycarbonyl), an acyloxy groups (preferably having 2 to 30 carbon atoms, more preferably having 2 to 20 carbon atoms, and particularly preferably having 2 to 10 carbon atoms, such as acetoxy and benzoyloxy), an acylamino group (preferably having 2 to 30 carbon atoms, more preferably having 2 to 20 carbon atoms, and particularly preferably having 2 to 10 carbon atoms, such as acetylamino and benzoylamino), an alkoxycarbonylamino group (preferably having 2 to 30 carbon atoms, more preferably having 2 to 20 carbon atoms, and particularly preferably having 2 to 12 carbon atoms, such as methoxycarbonylamino), an aryloxycarbonylamino group (preferably having 7 to 30 carbon atoms, more preferably having 7 to 20 carbon atoms, and particularly preferably having 7 to 12 carbon atoms, such as phenyloxycarbonylamino), a sulfonylamino group (preferably having 1 to 30 carbon atoms, more preferably having 1 to 20 carbon atoms, and particularly preferably having 1 to 12 carbon atoms, such as methanesulfonylamino and benzenesulfonylamino), a sulfamoyl group (preferably having 0 to 30 carbon atoms, more preferably having 0 to 20 carbon atoms, and particularly preferably having 0 to 12 carbon atoms, such as sulfamoyl, methylsulfamoyl, dimethylsulfamoyl, and phenylsulfamoyl), a carbamoyl group (preferably having 1 to 30 carbon atoms, more preferably having 1 to 20 carbon atoms, and particularly preferably having 1 to 12 carbon atoms, such as carbamoyl, methylcarbamoyl, diethylcarbamoyl, and phenylcarbamoyl), an alkylthio group (preferably having 1 to 30 carbon atoms, more preferably having 1 to 20 carbon atoms, and particularly preferably having 1 to 12 carbon atoms, such as methylthio and ethylthio),

an arylthio group (preferably having 6 to 30 carbon atoms, more preferably having 6 to 20 carbon atoms, and particularly preferably having 6 to 12 carbon atoms, such as phenylthio), a heterocyclicthio group (preferably having 1 to 30 carbon atoms, more preferably having 1 to 20 carbon atoms, and particularly preferably having 1 to 12 carbon atoms, such as pyridylthio, 2-benzimizolylthio, 2-benzoxazolylthio, and 2-benzothiazolylthio), a sulfonyl group (preferably having 1 to 30 carbon atoms, more preferably having 1 to 20 carbon atoms, and particularly preferably having 1 to 12 carbon atoms, such as mesyl and tosyl), a sulfinyl group (preferably having 1 to 30 carbon atoms, more preferably having 1 to 20 carbon atoms, and particularly preferably having 1 to 12 carbon atoms, such as methanesulfinyl and benzenesulfinyl), a ureide group (preferably having 1 to 30 carbon atoms, more preferably having 1 to 20 carbon atoms, and particularly preferably having 1 to 12 carbon atoms, such as ureide, methylureide, and phenylureide), a phosphoric amide group (preferably having 1 to 30 carbon atoms, more preferably 1 to 20 carbon atoms, and particularly preferably 1 to 12 carbon atoms, such as diethylphosphoric amide and phenylphosphoric amide), a hydroxy group, a mercapto group, a halogen atom (such as a fluorine atom, a chlorine atom, a bromine atom, and an iodine atom), a cyano group, a sulfo group, a carboxyl group, a nitro group, a hydroxamic acid group, a sulfino group, a hydrazino group, an imino group, a heterocyclic group (preferably having 1 to 30 carbon atoms and more preferably 1 to 12 carbon atoms; examples of the heteroatom(s) include a nitrogen atom, an oxygen atom, and a sulfur atom, specifically such as imidazolyl, pyridyl, quinolyl, furyl, thienyl, piperidyl, morpholino, benzoxazolyl, benzimidazolyl, benzothiazolyl, carbazolyl, and azepinyl), a silyl group (preferably having 3 to 40 carbon atoms, more preferably 3 to 30 carbon atoms, and particularly preferably 3 to 24 carbon atoms, such as trimethylsilyl and triphenylsilyl), and a silyloxy group (preferably having 3 to 40 carbon atoms, more preferably 3 to 30 carbon atoms, and particularly preferably 3 to 24 carbon atoms, such as trimethylsilyloxy and triphenylsilyloxy). These substituents may be further substituted.

R⁷⁰¹, R⁷⁰³, R⁷¹², and R⁷¹⁴ are preferably a hydrogen atom, an alkyl group, an alkoxy group, and an amino group, more preferably a hydrogen atom and an alkyl group, and still more preferably a hydrogen atom.

R⁷⁰² and R⁷¹³ are preferably a hydrogen atom, an alkyl group, an alkoxy group, and an amino group, more preferably a hydrogen atom, an alkyl group, and an alkoxy group, and still more preferably a hydrogen atom, an alkoxy group, and dialkylamino group.

R⁷⁰⁴, R⁷⁰⁶, R⁷⁰⁹, and R⁷¹¹ are preferably a hydrogen atom, a fluorine atom, a fluorine-substituted alkyl group, a fluorine-substituted aryl group, a heteroaryl group, a cyano group, a carbonyl group, and a sulfonyl group, more preferably a fluorine atom, a perfluoroalkyl group, a perfluoroaryl group, and a cyano group, still more preferably a fluorine atom and a cyano group, and particularly preferably a fluorine atom.

R⁷⁰⁵ and R⁷¹⁰ are preferably a hydrogen atom, a fluorine atom, a fluorine-substituted alkyl group, an aryl group, a heteroaryl group, a cyano group, a carbonyl group, and a sulfonyl group, more preferably a fluorine atom, a perfluoroalkyl group, a perfluoroaryl group, and a cyano group, still more preferably a perfluoroalkyl group, a perfluoroaryl group, and a cyano group, and particularly preferably a cyano group.

R⁷⁰⁷ and R⁷⁰⁸ are preferably a hydrogen atom, a fluorine atom, a fluorine-substituted alkyl group, a fluorine-substituted aryl group, and a heteroaryl group, more preferably a hydrogen atom and a fluorine atom, and still more preferably a hydrogen atom.

The compound represented by the formula (8) is described.

X⁸¹, X⁸³, Q⁸⁵, Y⁸¹, and R⁸⁰¹ to R⁸¹⁴ are respectively synonymous with X⁷¹, X⁷³, Q⁷⁵, Y⁷¹, and R⁷⁰¹ to R⁷¹⁴ in the formula (7), and the preferred range is also the same. X⁸⁴ and Q⁸⁶ are respectively synonymous with X⁷³ and Q⁷⁵ in the formula (7), and the preferred range is also the same.

As described above, the pentadentate or hexadentate metal complex in the present invention is preferably contained as a phosphorescence material, in the luminescent layer.

If the pentadentate or hexadentate metal complex is used as a phosphorescence material, the phosphorescence-quantum yield of the phosphorescence material is preferably 30% or more, more preferably 50% or more, still more preferably 70% or more, and particularly preferably 90% or more.

The phosphorescence-quantum yield of the phosphorescence material can be measured for example, by freeze-deaerating the phosphorescence material (for example, in the concentration of 1×10⁻³ mol/l) dissolved in an organic solvent (such as toluene and dichloroethane), and photo-irradiating at room temperature, and comparing the amount of luminescence at this time with that of a material (such as fluoresceine, anthracene, and rhodamine) whose absolute fluorescence-quantum yield is known.

The phosphorescence lifetime of the phosphorescence material is preferably 10 μs or less, more preferably 5 μs or less, and still more preferably 3 μs or less.

The phosphorescence lifetime of the phosphorescence material can be measured for example, by freeze-deaerating the phosphorescence material (for example, in the concentration of 1×10⁻³ mol/l) dissolved in an organic solvent (such as toluene and dichloroethane), and photo-irradiating at room temperature, and measuring the emission lifetime at this time.

The pentadentate or hexadentate metal complex in the present invention may be a low molecular weight compound, an oligomer compound, or a polymer compound having a metal complex in the main chain or side chains (the weight-average molecular weight (indicated as the molecular weight of polystyrene) is preferably 1000 to 5000000, more preferably 2000 to 1000000, and still more preferably 3000 to 100000).

The pentadentate or hexadentate metal complex in the present invention is preferably a low molecular weight compound.

Next, examples of compounds [exemplary compounds (1-1) to (1-32)] of the pentadentate or hexadentate metal complex of the present invention are shown. However, the present invention is not limited to them.

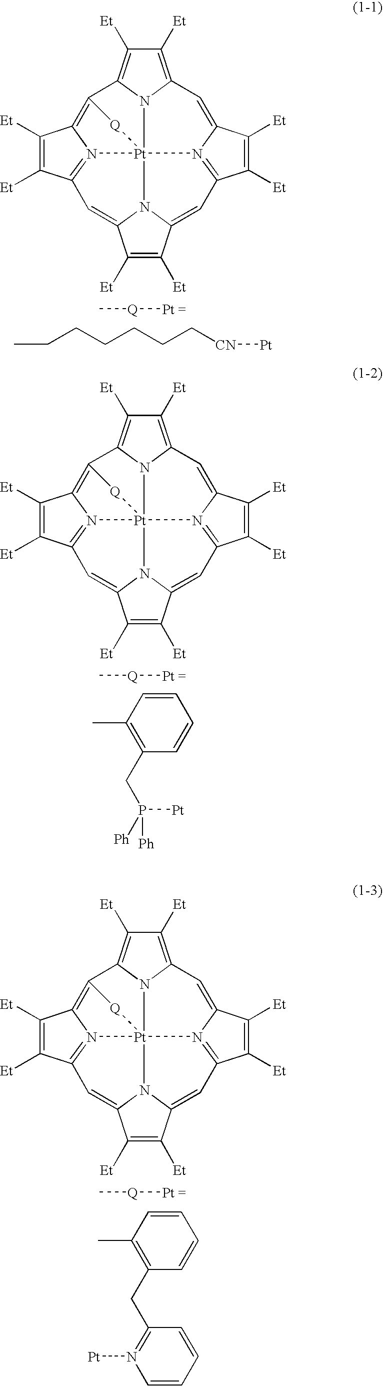

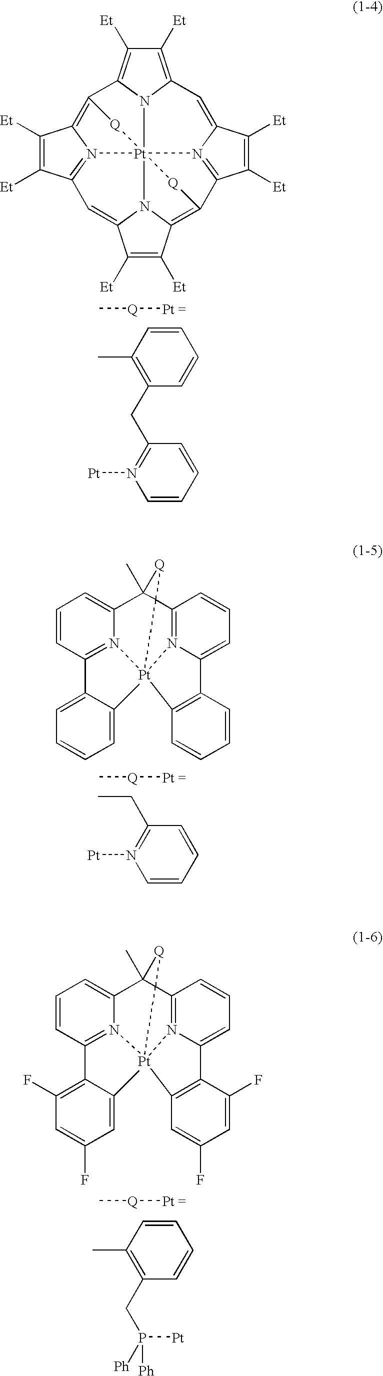

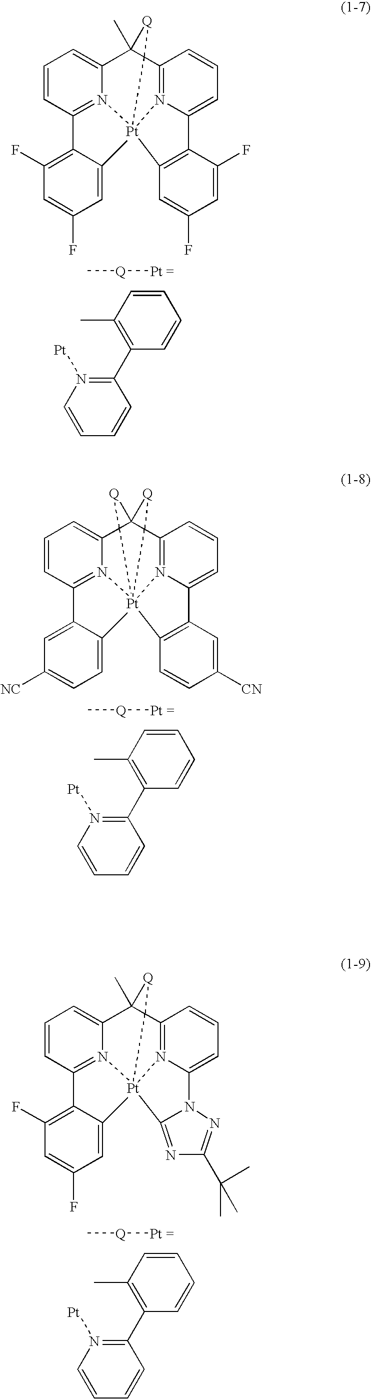

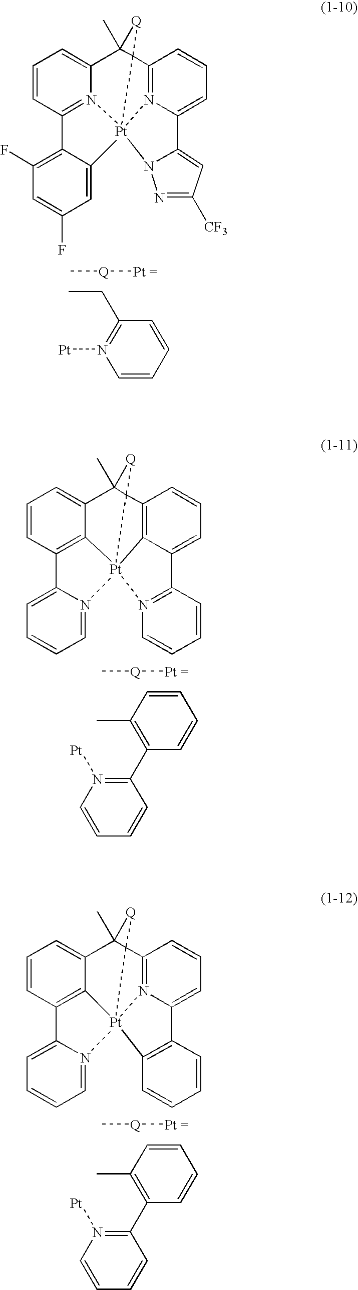

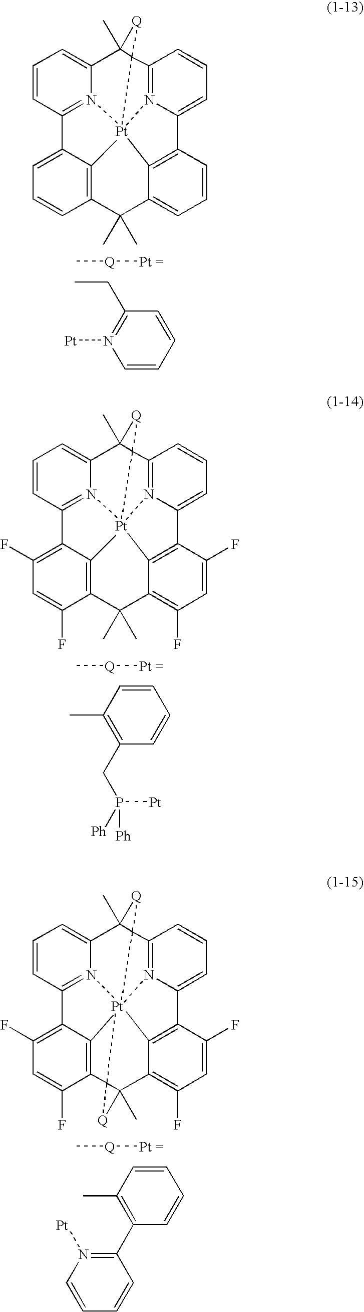

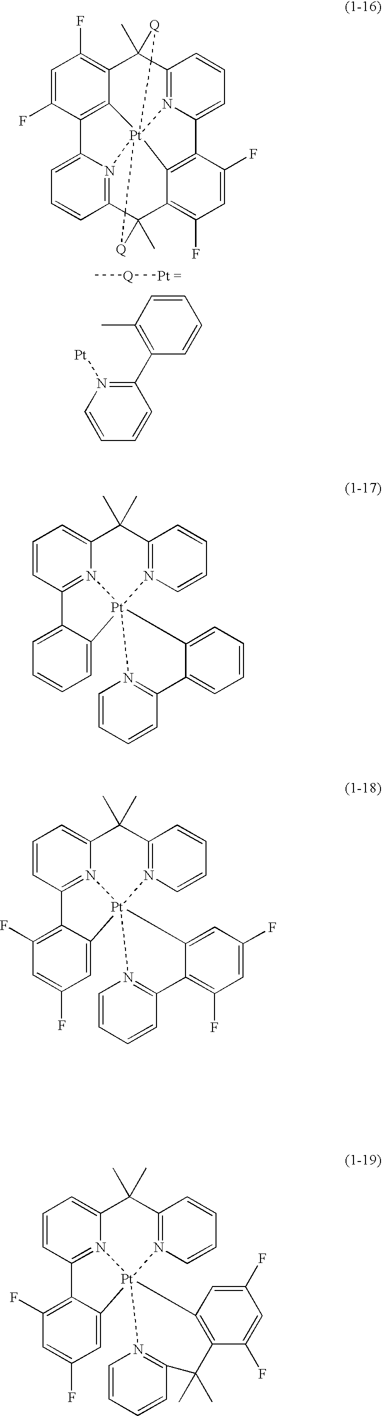

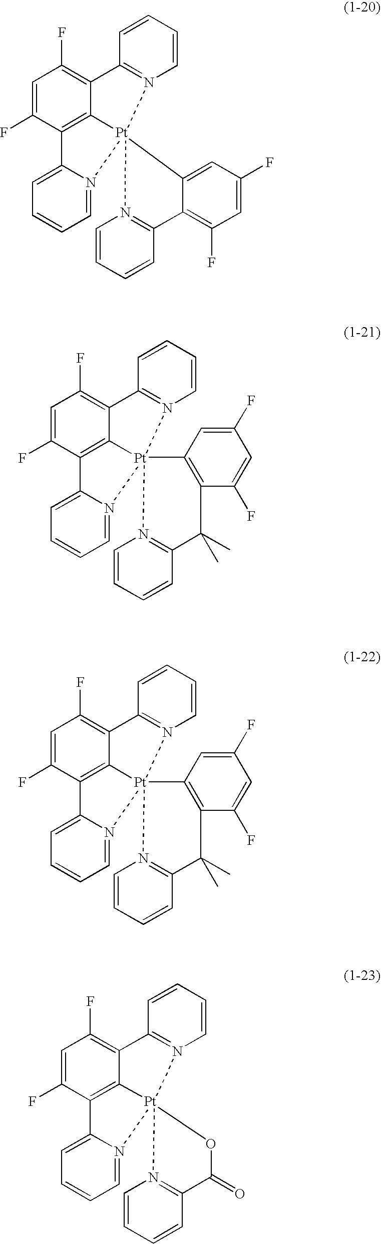

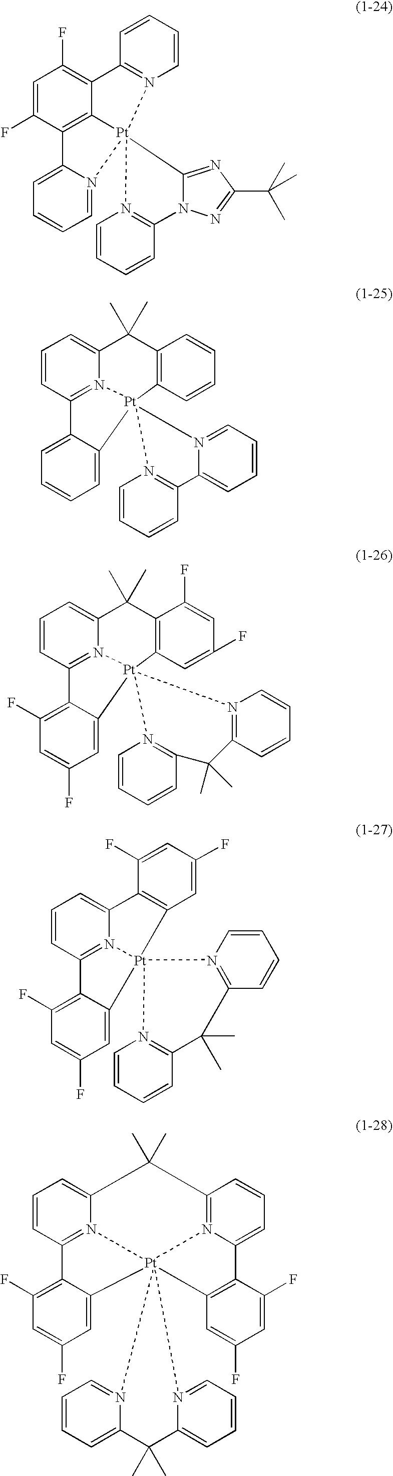

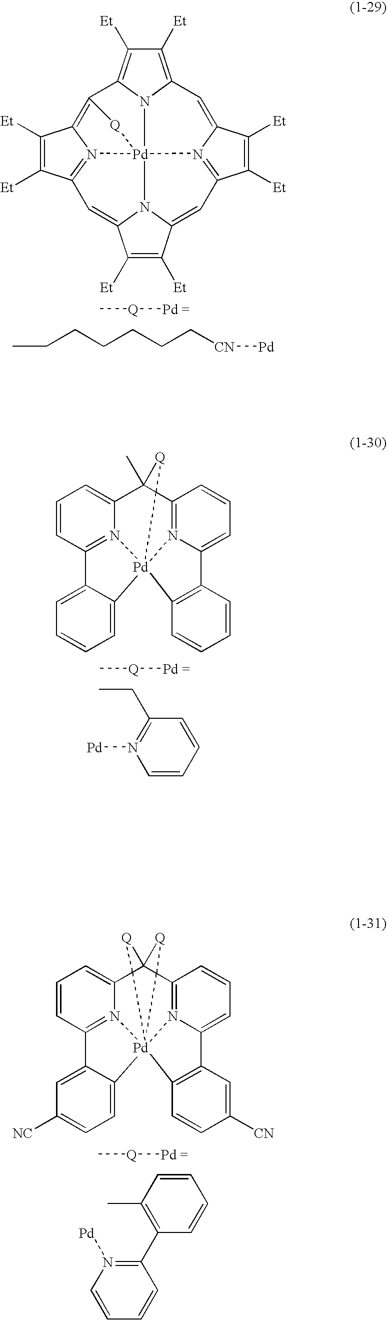

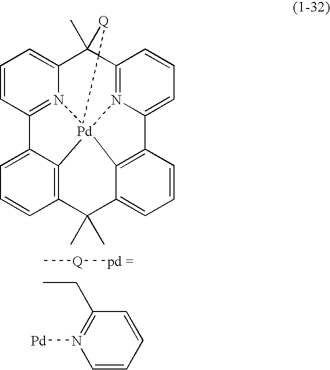

One type of the pentadentate or hexadentate metal complex of the present invention may be solely used, or two types or more may be used in combination.

In one organic compound layer, the content of the pentadentate or hexadentate metal complex is preferably 0.1 to 99 mass %, more preferably 1 to 50 mass %, and still more preferably 3 to 20 mass %.

The organic compound layer containing the pentadentate or hexadentate metal complex of the present invention is preferably a luminescent layer.

The pentadentate or hexadentate metal complex of the present invention can be synthesized by mixing, for example, a ligand and a metal source (such as platinum chloride, palladium chloride, potassium chloroplatinate, sodium chloropalladate, platinum bromide, and platinum acetylacetone complex), under the existence or non-existence of a solvent (such as acetonitrile, benzonitrile, acetic acid, ethanol, methoxyethanol, glycerol, water, and mixed solvents thereof). An additive (such as silver trifluoromethanesulfonate) which activates the reaction may be added, or the reaction may be performed under the existence of an inert gas (such as nitrogen and argon).

The reaction temperature is not specifically limited. However, −30° C. to 400° C. is preferred, 0° C. to 350° C. is more preferred, and 25° C. to 300° C. is still more preferred.

For example, the abovementioned exemplary compound (1-5) may be synthesized from publicly known compounds, by the following scheme.

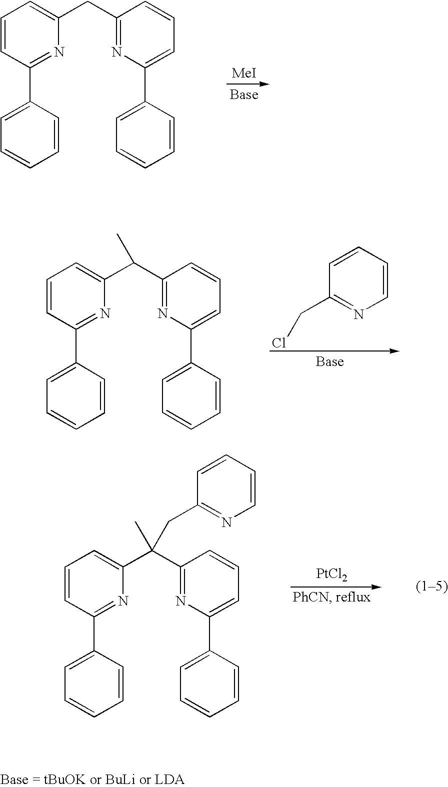

Hereunder is a detailed description of preferred aspects of the organic electroluminescent device (the organic electroluminescent device of the present invention) containing the pentadentate or hexadentate metal complex of the present invention in the luminescent layer.

The external quantum efficiency of the organic electroluminescent device of the present invention is preferably 5% or more, more preferably 10% or more, and still more preferably 13% or more. Regarding the numerical value of the external quantum efficiency, the maximum value of the external quantum efficiency when the device is driven at 20° C., or the value of the external quantum efficiency around 100 to 300 cd/m² when the device is driven at 20° C. can be used.

The internal quantum efficiency of the organic electroluminescent device of the present invention is preferably 30% or more, more preferably 50% or more, and still more preferably 70% or more. The internal quantum efficiency of the device can be calculated by internal quantum efficiency=external quantum efficiency/light extraction efficiency. The light extraction efficiency of a normal organic EL device is about 20%. However, the light extraction efficiency of the organic electroluminescent device of the present invention can be made 20% or more, by devising the shape of the substrate, the shape of the electrode, the thickness of the organic layer, the thickness of the inorganic layer, the refractive index of the organic layer, the refractive index of the inorganic layer, and the like.

The details of the respective layers constituting the organic electroluminescent device of the present invention are as described later. However, preferably, the device has at least three layers of a hole transport layer, a luminescent layer, and an electron transport layer.

The luminescent layer of the present invention preferably contains the pentadentate or hexadentate metal complex as a host material and a phosphorescence material, from the viewpoint of improving the luminous efficiency and the drive durability.

The ionization potential of the host material contained in the luminescent layer is preferably 5.8 eV or more but 6.3 eV or less, more preferably 5.95 eV or more but 6.25 eV or less, and still more preferably 6.0 eV or more but 6.2 eV or less, from the viewpoint of decreasing the driving voltage of the device.

The electron mobility of the host material contained in the luminescent layer is preferably 1×10⁻⁶ cm²/Vs or more but 1×10⁻¹ cm²/Vs or less, more preferably 5×10⁻⁶ cm²/Vs or more but 1×10⁻² cm²/Vs or less, still more preferably 1×10⁻⁵ cm²/Vs or more but 1×10⁻² cm²/Vs or less, and particularly preferably 5×10⁻⁵ cm²/Vs or more but 1×10⁻² cm²/Vs or less, from the viewpoint of decreasing the driving voltage of the device.

The hole mobility of the host material contained in the luminescent layer is preferably 1×10⁻⁶ cm²/Vs or more but 1×10⁻¹ cm²/Vs or less, more preferably 5×10⁻⁶ cm²/Vs or more but 1×10⁻² cm²/Vs or less, still more preferably 1×10⁻⁵ cm²/Vs or more but 1×10⁻² cm²/Vs or less, and particularly preferably 5×10⁻⁵ cm²/Vs or more but 1×10⁻² cm²/Vs or less, from the viewpoint of decreasing the driving voltage of the device.

The glass transition point of the host material contained in the luminescent layer of the present invention, the electron transport material contained in the electron transport layer, and the hole transport material contained in the hole transport layer are preferably 90° C. or more but 400° C. or less, more preferably 100° C. or more but 380° C. or less, still more preferably 120° C. or more but 370° C. or less, and particularly preferably 140° C. or more but 360° C. or less, from the viewpoint of improving the thermal stability of the device.

Moreover, if the organic electroluminescent device of the present invention is applied to blue luminescence, the following form is preferred.

The emission peak wavelength is preferably 390 nm or more but 495 nm or less, and more preferably 400 nm or more but 490 nm or less, from the viewpoint of blue color purity. Moreover, the organic electroluminescent device of the present invention may also have the emission peak wavelength at 500 nm or more, and may be a white luminescent device.

The x value of the CIE chromaticity value of luminescence is preferably 0.22 or less, and more preferably 0.20 or less, from the viewpoint of blue color purity.

The y value of the CIE chromaticity value of luminescence is preferably 0.25 or less, more preferably 0.20 or less, and still more preferably 0.15 or less, from the viewpoint of blue color purity.

The half value width of the emission spectrum is preferably 100 nm or less, more preferably 90 nm or less, still more preferably 80 nm or less, and particularly preferably 70 nm or less, from the viewpoint of blue color purity.

The T₁ level (energy level in the minimum triplet excited state) of the phosphorescence material in the luminescent layer is preferably 60 kcal/mol or more (251.4 kJ/mol or more) but 90 kcal/mol or less (377.1 kJ/mol or less), more preferably 62 kcal/mol or more (259.78 kJ/mol or more) but 85 kcal/mol or less (356.15 kJ/mol or less), and still more preferably 65 Kcal/mol or more (272.35 kJ/mol or more) but 80 kcal/mol or less (335.2 kJ/mol or less), from the viewpoint of improving the luminous efficiency of blue luminescence.

The T₁ level (energy level in the minimum triplet excited state) of the host material in the luminescent layer is preferably 60 kcal/mol or more (251.4 kJ/mol or more) but 90 kcal/mol or less (377.1 kJ/mol or less), more preferably 62 kcal/mol or more (259.78 kJ/mol or more) but 85 kcal/mol or less (356.15 kJ/mol or less), and still more preferably 65 Kcal/mol or more (272.35 kJ/mol or more) but 80 kcal/mol or less (335.2 kJ/mol or less), from the viewpoint of improving the luminous efficiency of blue luminescence.

The T₁ level (energy level in the minimum triplet excited state) of a layer (such as the hole transport layer, the electron transport layer, the charge block layer, and the exciton block layer) adjacent to the luminescent layer is preferably 60 kcal/mol or more (251.4 kJ/mol or more) but 90 kcal/mol or less (377.1 kJ/mol or less), more preferably 62 kcal/mol or more (259.78 kJ/mol or more) but 85 kcal/mol or less (356.15 kJ/mol or less), and still more preferably 65 Kcal/mol or more (272.35 kJ/mol or more) but 80 kcal/mol or less (335.2 kJ/mol or less), from the viewpoint of improving the luminous efficiency of blue luminescence.

The structure of the organic electroluminescent device of the present invention is described more in detail.

The organic electroluminescent device of the present invention comprises one or more organic compound layers including a luminescent layer between a pair of electrodes of anode and cathode. The organic electroluminescent device of the present invention contains the pentadentate or hexadentate metal complex in at least one of the organic compound layers The organic electroluminescent device of the present invention may have the hole injection layer, the hole transport layer, the electron injection layer, the electron transport layer, the protective layer, and the like, in addition to the luminescent layer. The respective layers may have other functions. Various materials may be used for forming the respective layers.

There is no specific requirement for the system, the driving method, the operation mode, and the like of the organic electroluminescent device of the present invention.

Moreover, the organic electroluminescent device of the present invention may improve the light extraction efficiency by various publicly known schemes. For example, it is possible to improve the light extraction efficiency, so as to improve the external quantum efficiency, by processing the surface shape of the substrate (for example, forming minute relief patterns), controlling the refractive index of the substrate/ITO layer/organic compound layer, controlling the thickness of the substrate/ITO layer/organic compound layer, and so forth.

The organic electroluminescent device of the present invention may be a system of taking out the luminescence from the cathode side; a so called a top emission system, (described in Japanese Unexamined Patent Publication Nos. 2003-208109, 2003-248441, 2003-257651, 2003-282261, and the like).

The substrate used in the organic electroluminescent device of the present invention is not particularly limited, and may be: an inorganic material such as zirconia stabilized with yttrium, or glass; a polyester such as polyethylene terephthalate, polybutylene terephthalate, or polyethylene naphthalate; or a polymer material such as polyethylene, polycarbonate, polyether sulfone, polyarylate, allyl diglycol carbonate, polyimide, polycycloolefin, norbornene resin, poly(chlorotrifluoroethylene), TEFRON(registered trademark), or a polytetrafluoroethylene-polyethylene copolymer.

The anode serves to supply holes to, for example, the hole injection layer, the hole transport layer, and the luminescent layer. As the material of the anode, a metal, alloy, metal oxide, electroconductive compound or mixture of these materials may be used and a material having a work function of 4 eV or more is preferable.

Specific examples of the anode material include conductive metal oxides such as tin oxide, zinc oxide, indium oxide and indium tin oxide (ITO), metals such as gold, silver, chromium and nickel, mixtures or laminates of these metals and electroconductive metal oxides, inorganic conductive materials such as copper iodide and copper sulfide, organic electroconductive materials such as polyaniline, polythiophene and polypyrrole and laminates of these materials and ITO. Among these materials, electroconductive metal oxides are preferable and, particularly, ITO is preferable from the viewpoint of productivity, high electroconductivity and transparency. Usually the film thickness of the anode is preferably in a range between 10 nm and 5 μm, more preferably 50 nm and 1 μm, and still more preferably 100 nm and 500 nm, though it may be suitably selected according to the material to be used.

The anode usually has a constitution in which an anode-material layer is formed on soda lime glass, non-alkali glass, a transparent resin substrate or the like. When glass is used, the glass is preferably non-alkali glass so as to reduce ions eluted from the glass. When soda lime glass is used, a barrier coat such as silica is preferably provided on the soda lime glass. The thickness of the substrate is not particularly limited insofar as it is sufficient for maintaining its mechanical strength. When glass is used, the thickness of the substrate is usually 0.2 mm or more, preferably 0.7 mm or more.

Various methods may be used to form the anode, according to the material. For example, ITO film may be formed by an electron beam method, by a sputtering method, by a resistance heating deposition method, by a chemical reaction method (sol/gel method and the like), or by a method of applying a dispersion of indium tin oxide.

By subjecting the anode to washing or any other treatment, the driving voltage of the device can be lowered, and luminous efficiency can be increased. For example, in the case of ITO, UV-ozone treatment, plasma treatment, and the like are effective.

The cathode supplies electrons to the electron injection layer, the electron transport layer, the luminescent layer, or the like. The cathode material is selected in consideration of: the adhesion of the cathode to its adjacent layer such as the electron injection layer, the electron transport layer, or the luminescent layer; ionization potential of the cathode material; stability of the cathode material; and the like. As the cathode material, it is possible to use a metal, an alloy, a metal halide, a metal oxide, an electroconductive compound or a mixture thereof, and specific examples of the cathode material include alkali metals (for example, Li, Na, and K) and fluorides or oxides thereof, alkaline earth metals (for example, Mg and Ca) and fluorides or oxides thereof, gold, silver, lead, aluminum, a sodium-potassium alloy or a mixed metal of sodium and potassium, a lithium-aluminum alloy or a mixed metal of lithium and aluminum, a magnesium-silver alloy or a mixed metal of magnesium and silver, and rare earth metals such as indium, ytterbium. The cathode material is preferably a material having a work function of 4 eV or lower, more preferably aluminum, a lithium-aluminum alloy or a mixed metal of lithium and aluminum, or a magnesium-silver alloy or a mixed metal of magnesium and silver. The cathode may have a single-layer structure of the above compound or mixture, or may have a laminated structure comprising compounds selected from the above compounds and mixtures. For example, a laminated structure of aluminum and lithium fluoride or a laminated structure of aluminum and lithium oxide are preferable. The thickness of the cathode can be selected suitably depending on its material, and usually the thickness of the cathode is preferably in the range of 10 nm to 5 μm, more preferably 50 nm to 1 μm, and still more preferably 100 nm to 1 μm.

Methods such as an electron beam method, a sputtering method, a resistance heating deposition method, a coating method, and a transfer method are used to form the cathode. A metal can be singly deposited, or two components or more can be simultaneously deposited. Furthermore, it is also possible to simultaneously deposit a plurality of metals to form an alloy electrode. Moreover, a previously adjusted alloy may be deposited.

The sheet resistance of the anode and the cathode is low, and several hundreds Ω/sq is preferred.

As described above, the organic electroluminescent device of the present invention comprises organic compound layers such as the hole injection layer, the hole transport layer, the electron injection layer, and the electron transport layer, and the like, in addition to the luminescent layer. A form having at least three layers of the hole transport layer, the luminescent layer, and the electron transport layer is preferred.

The method of forming the organic compound layer of the present invention is not specifically limited, however there are used methods such as a resistance heating deposition method, an electron beam method, a sputtering method, a molecular lamination method, a coating method (such as a spray coating method, a dip coating method, an impregnation method, a roll coating method, a gravure coating method, a reverse coating method, a roll brushing method, an air knife coating method, a curtain coating method, a spin coating method, a flow coating method, a bar coating method, a micro gravure coating method, an air doctor coating method, a blade coating method, a squeeze coating method, a transfer roll coating method, a kiss coating method, a cast coating method, an extrusion coating method, a wire bar coating method, and a screen coating method), an ink-jet method, a printing method, a transfer method, and the like, and preferably the resistance heating deposition method, the coating method, and the transfer method in terms of properties and manufacture.

As described above, the luminescent layer of the present invention preferably contains the pentadentate or hexadentate metal complex, and more preferably contains it as a phosphorescence material.

The material contained in the luminescent layer may be anything insofar as it is capable of forming a layer having; a function of injecting holes from the anode, the hole injection layer, or the hole transport layer, and of injecting electrons from the cathode, the electron injection layer, or the electron transport layer, when the electric field is applied, a function of moving the injected charge, and a function of providing a field for recombining the holes and electrons, so as to emit light.

Examples of the material contained in the luminescent layer, in addition to the abovementioned pentadentate or hexadentate metal complex of the present invention, include various metal complexes such as metal complexes and rare earth complexes of benzoxazole, benzimidazole, benzothiazole, styryl benzene, polyphenyl, diphenyl butadiene, tetraphenyl butadiene, naphthalimide, coumarin, perylene, perinone, oxadiazole, aldazine, pyralizine, cyclopentadiene, bis-styryl anthracene, quinacridone, pyrrolopyridine, thiadiazolopyridine, cyclopentadiene, styryl amine, aromatic dimethylidene compounds and 8-quinolinol, polymer compounds such as polythiophene, polyphenylene, and polyphenylene vinylene, organic silanes, iridium trisphenyl pyridine complex, and transition metal complexes such as platinum porphyrin complex, and derivatives thereof The thickness of the luminescent layer is not specifically limited. However, normally, it is preferably within a range between 1 nm and 5 μm, more preferably 5 nm and 1 μm, and still more preferably 10 nm and 500 nm.

The method of forming the luminescent layer is not specifically limited. However, among the abovementioned methods of forming the organic compound layer, there are used the resistance heating deposition method, the electron beam method, the sputtering method, the molecular lamination method, the coating method, the ink-jet method, the printing method, the LB method, the transfer method, and the like, and preferably the resistance heating deposition and the coating method.

The luminescent layer may be formed from a single compound, or may be formed from a plurality of compounds.

Moreover, the luminescent layer may have one (single layer) or a plurality (laminated structure) of layers. The respective layers may emit light with different luminescent colors, to emit for example white light as a whole. A single luminescent layer may emit white light. In the case of a plurality of luminescent layers, the respective luminescent layers may be formed from a single material, or may be formed from a plurality of compounds.

If the luminescent layer has a laminated structure, the number of laminations is preferably 2 layers or more but 50 layers or less, more preferably 4 layers or more but 30 layers or less, and still more preferably 6 layers or more but 20 layers or less.

If the luminescent layer has a laminated structure, the thickness of the respective layers constituting the laminated structure is not specifically limited. However, it is preferably 0.2 nm or more but 20 nm or less, more preferably 0.4 nm or more but 15 nm or less, still more preferably 0.5 nm or more but 10 nm or less, and particularly preferably 1 nm or more but 5 nm or less.

The luminescent layer may comprise a plurality of domain structures. The luminescent layer may comprise other domain structures. For example, the luminescent layer may comprise an approximate 1 nm³ portion made of a mixture of a host material A and a phosphorescence material B and another approximate 1 nm³ portion made of a mixture of a host material C and a phosphorescence material D. The diameter of each domain is preferably 0.2 nm to 10 nm, more preferably 0.3 nm to 5 nm, still more preferably 0.5 nm to 3 nm, and particularly preferably 0.7 nm to 2 nm.

The luminescent layer may further contain a blue fluorescence compound. Moreover, a multi color luminescent device or a full color luminescent device may be produced by simultaneously using a blue luminescent device containing the blue fluorescence compound and the organic electroluminescent device of the present invention.

The material contained in the hole injection layer and the hole transport layer may be anything insofar as it has any one of, a function of injecting holes from the anode, a function of transporting the holes, and a function of blocking electrons injected from the cathode.

Specific examples of the material contained in the hole injection layer and the hole transport layer include, carbazole, triazole, oxazole, oxadiazole, imidazole, polyarylalkane, pyrazoline, pyrazolone, phenylenediamine, arylamine, amino-substituted chalcone, styrylanthracene, fluorenone, hydrazone, stilbene, silazane, an aromatic tertiary amine compound, a styrylamine compound, an aromatic dimethylidyne compound, a porphyrin compound, a polysilane compound, poly(N-vinylcarbazole), an aniline copolymer, electroconductive oligomers such as thiophene oligomer and polythiophene, organic silanes, carbon films, compounds of the present invention, and derivatives thereof. The thickness of the hole injection layer and the hole transport layer are not specifically limited. However, normally, it is preferably within a range between 1 nm and 5 μm, more preferably 5 nm and 1 μm, and still more preferably 10 nm and 500 nm.

Each of the hole injection layer and the hole transport layer may have a single-layer structure comprising one or more of the abovementioned materials, or a multi-layer structure comprising a plurality of layers having the same composition or different compositions.

As a method of forming the hole injection layer and the hole transport layer, a formation vacuum deposition method, an LB method, a method in which the aforementioned hole injection or transfer materials are dissolved or dispersed in a solvent and the resulting solution is used for coating, an ink-jet method, a printing method, and [or] a transfer method is used. In the case of the coating method, these materials may be dissolved or dispersed together with a resin component, and examples of the resin component include polyvinyl chloride, polycarbonate, polystyrene, polymethyl methacrylate, polybutyl methacrylate, polyester, polysulfone, polyphenylene oxide, polybutadiene, poly(N-vinyl carbazole), hydrocarbon resin, ketone resin, phenoxy resin, polyamide, ethyl cellulose, vinyl acetate, ABS resin, polyurethane, melamine resin, unsaturated polyester resin, alkyd resin, epoxy resin, and silicon resin.

The material contained in the electron injection layer and the electron transport layer may be anything insofar as it has any one of; a function of injecting electrons from the cathode, a function of transporting the electrons, and a function of blocking holes injected from the anode. Specific examples of the material contained in the electron injection layer and the electron transport layer include, triazole, oxazole, oxadiazole, imidazole, fluorenone, anthraquinodimetane, anthrone, diphenylquinone, thiopyran dioxide, carbodiimide, fluorenylidene methane, distyrylpyrazine, naphthalene, aromatic tetracarboxlic acid anhydride such as perylene, phthalocyanine, metal complexes including metal complexes of 8-quinolinol, various metal complexes such as metal phthalocyanine and metal complexes with benzoxazole and/or benzothiazole ligands, organic silanes, and derivatives thereof

The thickness of the electron injection layer and the electron transport layer are not specifically limited. However, normally, it is preferably within a range between 1 nm and 5 ρm, more preferably 5 nm and 1 μm, and still more preferably 10 nm and 500 nm.

Each of the electron injection layer and the electron transport layer may have a single-layer structure comprising one or more of the abovementioned materials, or a multi-layer structure comprising a plurality of layers having the same composition or different compositions.

As a method of forming the electron injection layer and the electron transfer layer, a vacuum deposition method, an LB method, a method in which the aforementioned electron injection or transfer materials are dissolved or dispersed in a solvent and the resulting solution is used for coating, an ink jet method, a printing method or a transfer method is used. In the case of the coating method, these materials may be dissolved or dispersed together with a resin component. As the resin component, those given as the examples in the case of the hole injection or transfer layer may be used.

The organic electroluminescent device of the present invention may have a protective layer in order to prevent moisture and oxygen from entering. The material contained in the protective layer may be anything insofar as it has a function of preventing substances that accelerate deterioration of the device, such as moisture and oxygen, from entering the device. Specific examples thereof include metals such as In, Sn, Pb, Au, Cu, Ag, Al, Ti, and Ni, metal oxides such as MgO, SiO, SiO₂, Al₂O₃, GeO, NiO, CaO, BaO, Fe₂O₃, Y₂O₃, and TiO₂, metal fluorides such as MgF₂, LiF, AlF₃, and CaF₂, nitrides such as SiNₓ and SiOₓN_{y}, polyethylene, polypropylene, polymethyl methacrylate, polyimide, polyurea, polytetrafluoroethylene, polychlorotrifluoroethylene, polydichlorodifluoroethylene, a chlorotrifluoroethylene-dichlorodifluoroethylene copolymer, a copolymer obtained by copolymerizing a monomer mixture containing tetrafluoroethylene and at least one kind of comonomer, a fluorine-containing copolymer having a cyclic structure on a main chain of the copolymer, a water-absorbing substance having a water absorption of 1% or higher, and a damp proof substance having a water absorption of 0.1% or lower.

The method of forming the protective layer is not specifically limited. Examples of applicable methods include a vacuum deposition method, a sputtering method, a reactive sputtering method, an MBE (molecular beam epitaxy) method, a cluster ion beam method, an ion plating method, a plasma polymerization method (high-frequency excitation ion plating method), a plasma CVD method, a laser CVD method, a thermal CVD method, a gas source CVD method, a coating method, a printing method, and a transfer method.

Furthermore, in the present invention, a whole device according to the invention may be sealed with a sealing container. In a space between the sealing container and the luminescent device, a moisture absorbent or inert liquid may be filled in. The moisture absorbent is not limited to a particular one. For instance, barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite and magnesium oxide can be cited. The inert liquid is not limited to a particular one. For instance, paraffins, liquid paraffins, fluorine base solvents such as perfluoroalkane, perfluoroamine or perfluoroether, chlorine base solvents and silicone oils can be cited.

The usage of the organic electroluminescent device of the present invention is not specifically limited. However, it may be suitably used in fields of a display device, a display, a backlight, electrophotography, a light source for illumination, a light source for recording, a light source for exposure, a light source for reading, a sign, a sign board, interior lighting, and optical communication.

### EXAMPLE

Hereunder is a detailed description with reference to the following examples, but the present invention is not limited to these examples.

### Comparative Example 1

An ITO substrate was washed and put into a deposition device, and copper phthalocyanine was deposited thereon to have a thickness of 5 nm, on which NPD (N,N′-di-α-naphthyl-N,N′-diphenyl)-benzidine) was deposited to have a thickness of 40 nm. A compound having an octaethyl platinum porphyrin complex and CBP at a ratio of 6:94 (mass ratio) was deposited thereon to have a thickness of 30 nm. BAlq was deposited thereon to have a thickness of 6 nm. Alq (tris(8-hydroxyquinoline) aluminium complex) was deposited thereon to have a thickness of 20 nm. Lithium fluoride was deposited thereon to have a thickness of 3 nm, and then aluminium was deposited to have a thickness of 60 nm. As a result, the organic electroluminescent device of Comparative Example 1 was produced.

Using a source measure unit Type 2400 manufactured by Toyo Corporation, a direct constant voltage was applied to the resultant organic electroluminescent device to emit light. As a result, red luminescence was obtained.

The structures of octaethyl platinum porphyrin complex, CBP, and BAlq used for the above are shown below.

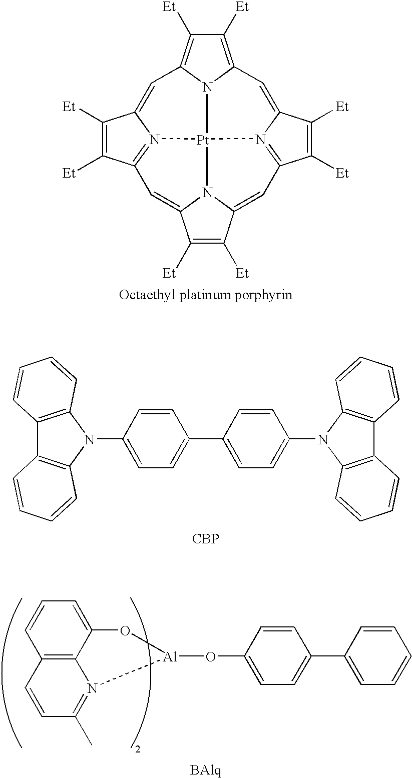

### Comparative Example 2

An ITO substrate was washed and put into a deposition device, and copper phthalocyanine was deposited thereon to have a thickness of 5 nm, on which α-NPD (N,N′-di-α-naphthyl-N,N′-diphenyl-benzidine) was deposited to have a thickness of 40 nm. A compound having a platinum complex A of the following structure and CBP at a ratio of 6:94 (mass ratio) was deposited thereon to have a thickness of 30 nm. BAlq was deposited thereon to have a thickness of 6 nm. Alq (tris(8-hydroxyquinoline) aluminium complex) was deposited thereon to have a thickness of 20 nm. Lithium fluoride was deposited thereon to have a thickness of 3 nm, and then aluminium was deposited to have a thickness of 60 nm. As a result, the organic electroluminescent device of Comparative Example 2 was produced.

Using a source measure unit Type 2400 manufactured by Toyo Corporation, a direct constant voltage was applied to the resultant organic electroluminescent device to emit light. As a result, green luminescence was obtained.

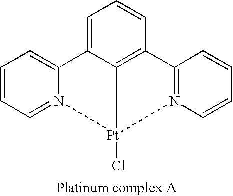

### Example 1

The organic electroluminescent device of Example 1 was produced in the same manner as that of the Comparative Example 1, except for that the exemplary compound (1-1) serving as the pentadentate metal complex of the present invention was used instead of octaethyl platinum porphyrin complex used for the organic electroluminescent device of Comparative Example 1.

Using a source measure unit Type 2400 manufactured by Toyo Corporation, a direct constant voltage was applied to the resultant organic electroluminescent device to emit light. As a result, red luminescence was obtained.

The drive durability of this device was about twice that of the device of Comparative Example 1.

### Example 2

The organic electroluminescent device of Example 2 was produced in the same manner as that of the Comparative Example 2, except that the exemplary compound (1-20) serving as the pentadentate metal complex of the present invention was used instead of the platinum complex A used for the organic electroluminescent device of Comparative Example 2.

Using a source measure unit Type 2400 manufactured by Toyo Corporation, a direct constant voltage was applied to the resultant organic electroluminescent device to emit light. As a result, blue-green luminescence was obtained.

The drive durability of this device was about twice that of the device of Comparative Example 2.

In addition, similar effects can be obtained in devices using the other pentadentate or hexadentate metal complexes of the present invention.

The present invention includes the following specific examples.

<1> An organic electroluminescent device comprising one or more organic compound layers including a luminescent layer between a pair of electrodes, wherein at least one of the organic compound layers contains a pentadentate or hexadentate metal complex having a bivalent platinum ion or a bivalent palladium ion as the central metal ion.

<2> The organic electroluminescent device according to <1>, wherein the pentadentate or hexadentate metal complex has a pentadentate or hexadentate ligand.

<3> The organic electroluminescent device according to <2>, wherein the pentadentate metal complex comprizing the pentadentate ligand is a compound represented by the following formula (1), formula (2), or formula (3):

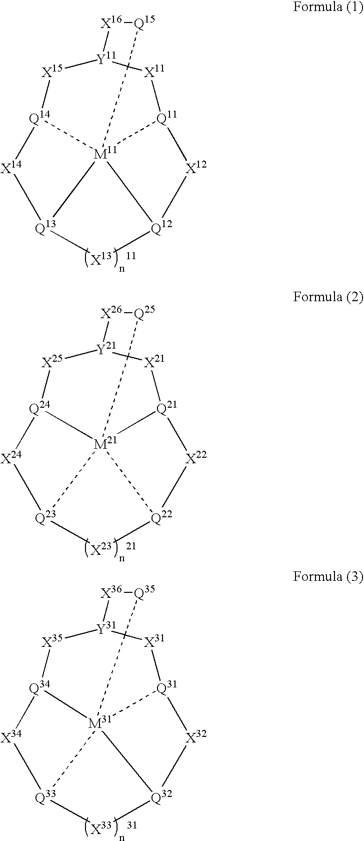

wherein in the formula (1), X¹¹ to X¹⁶ independently represent a single bond or a linking group; Q¹¹ to Q¹⁵ represent an atom group coordinated to M¹¹; Y¹¹ represents a linking group; n¹¹ represents 0 or 1; if n¹¹ is 0, there is no bond between Q¹² and Q¹³ X¹³; M¹¹ represents a bivalent platinum ion or a bivalent palladium ion;

wherein in the formula (2), X²¹ to X²⁶ independently represent a single bond or a linking group; Q²¹ to Q²⁵ represent an atom group coordinated to M²¹; Y²¹ represents a linking group; n²¹ represents 0 or 1; if n²¹ is 0, there is no bond between Q²² and Q²³ via X²³; M²¹ represents a bivalent platinum ion or a bivalent palladium ion;

wherein in the formula (3), X³¹ to X³⁶ independently represent a single bond or a linking group; Q³¹ to Q³⁵ represent an atom group coordinated to M³¹; Y³¹ represents a linking group; n³¹ represents 0 or 1; if n³¹ is 0, there is no bond between Q³² and Q³³ via X³³; M³¹ represents a bivalent platinum ion or a bivalent palladium ion.

<4> The organic electroluminescent device according to (2), wherein the hexadentate metal complex having the hexadentate ligand is a compound represented by the following formula (4), formula (5), or formula (6):

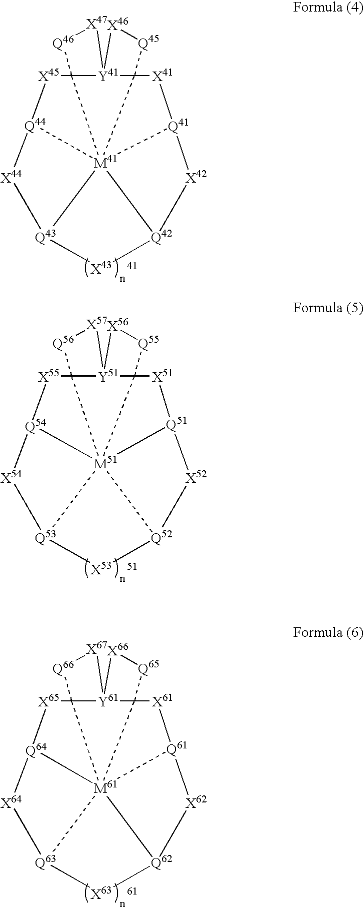

wherein in the formula (4), X⁴¹ to X⁴⁷ independently represent a single bond or a linking group; Q⁴¹ to Q⁴⁶ represent an atom group coordinated to M⁴¹; Y⁴¹ represents a carbon atom or a silicon atom; n⁴¹ represents 0 or 1; if n⁴¹ is 0, there is no bond between Q⁴² and Q⁴³ via X⁴³; M⁴¹ represents a bivalent platinum ion or a bivalent palladium ion;

wherein in the formula (5), X¹⁶ to X¹⁷ independently represent a single bond or a linking group; Q⁵¹ to Q⁵⁶ represent an atom group coordinated to M⁵¹; Y⁵¹ represents a carbon atom or a silicon atom; n⁵¹ represents 0 or 1; if n⁵¹ is 0, there is no bond between Q⁵² and Q⁵³ via X⁵³; M⁵¹ represents a bivalent platinum ion or a bivalent palladium ion;

wherein in the formula (6), X⁶¹ to X⁶⁷ independently represent a single bond or a linking group; Q⁶¹ to Q⁶⁶ represent an atom group coordinated to M⁶¹; Y⁶¹ represents a carbon atom or a silicon atom; n⁶¹ represents 0 or 1; if n⁶¹ is 0, there is no bond between Q62 and Q⁶³ via X⁶³; M⁶¹ represents a bivalent platinum ion or a bivalent palladium ion.

<5> The organic electroluminescent device according to <2>, wherein the pentadentate metal complex having the hexadentate ligand is a compound represented by the following formula (7):

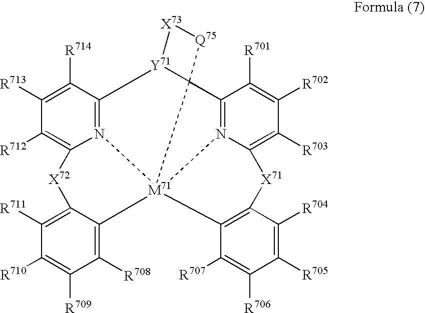

wherein in the formula (7), X⁷¹ to X⁷³ independently represent a single bond or a linking group; Q⁷⁵ represents an atom group coordinated to M⁷¹; Y⁷¹ represents a linking group; R⁷⁰¹ to R⁷¹⁴ independently represent a hydrogen atom or a substituent; R⁷⁰⁷ and R⁷⁰⁸ may be bonded; M⁷¹ represents a bivalent platinum ion or a bivalent palladium ion.

<6> The organic electroluminescent device according to <2>, wherein the hexadentate metal complex having the hexadentate ligand is a compound represented by the following formula (8):

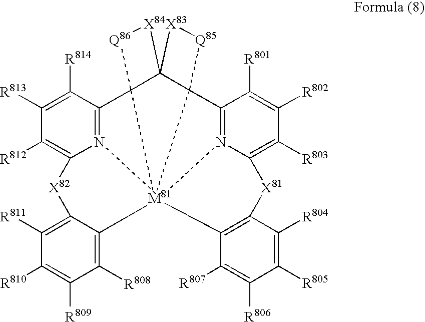

wherein in the formula (8), X⁸¹ to X⁸⁴ independently represent a single bond or a linking group; Q⁸⁵ and Q⁸⁶ represent an atom group coordinated to M⁸¹; R⁸⁰¹ to R⁸¹⁴ independently represent a hydrogen atom or a substituent; R⁸⁰⁷ and R⁸⁰⁸ may be bonded; M⁸¹ represents a bivalent platinum ion or a bivalent palladium ion.

<7> The organic electroluminescent device according to any one of <1> through <6>, wherein the pentadentate or hexadentate metal complex is a phosphorescence material.

<8> The organic electroluminescent device according to any one of <1> through <6>, wherein the thickness of the luminescent layer is 5 nm to 1 μm.

<9> The organic electroluminescent device according to any one of <1> through <6>, wherein the luminescent layer is a laminated structure having 4 layers or more but 30 layers or less.

<10> The organic electroluminescent device according to any one of <1> through <6>, wherein the thickness of the respective layers constituting the laminated structure is 0.2 nm or more but 20 nm or less.

<11> A multi color luminescent device comprising a blue luminescent device containing a blue fluorescence compound and the organic electroluminescent device according to any one of <1> through <6>

According to the present invention, it is possible to provide an organic electroluminescent device which is superior in at least either high luminous efficiency or drive durability.

All publications, patent applications, and technical standards mentioned in this specification are herein incorporated by reference to the same extent as if each individual publication, patent application, or technical standard was specifically and individually indicated to be incorporated by reference.

It will be obvious to those having skill in the art that many changes may be made in the above-described details of the preferred embodiments of the present invention. The scope of the invention, therefore, should be determined by the following claims.

1. An organic electroluminescent device comprising one or more organic compound layers including a luminescent layer between a pair of electrodes, wherein at least one of the organic compound layers contains a pentadentate or hexadentate metal complex having a bivalent platinum ion or a bivalent palladium ion as the central metal ion.

2. The organic electroluminescent device according to claim 1, wherein the pentadentate or hexadentate metal complex has a pentadentate or hexadentate ligand.

3. The organic electroluminescent device according to claim 2, wherein the pentadentate metal complex having the pentadentate ligand is a compound represented by the following formula (1), formula (2), or formula (3): 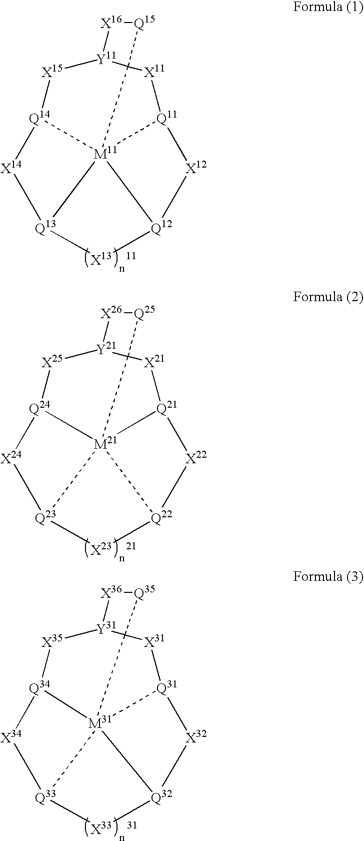
wherein in the formula (1), X¹¹ to X¹⁶ independently represent a single bond or a linking group; Q¹¹ to Q¹⁵ represent an atom group coordinated to M¹¹; Y¹¹ represents a linking group; n¹¹ represents 0 or 1; if n¹¹ is 0, there is no bond between Q¹² and Q¹³ via X¹³; M¹¹ represents a bivalent platinum ion or a bivalent palladium ion;
wherein in the formula (2), X²¹ to X²⁶ independently represent a single bond or a linking group; Q²¹ to Q²⁵ represent an atom group coordinated to M²¹; Y²¹ represents a linking group; n²¹ represents 0 or 1; if n²¹ is 0, there is no bond between Q²² and Q²³ via X; M²¹ represents a bivalent platinum ion or a bivalent palladium ion;
wherein in the formula (3), X³¹ to X³⁶ independently represent a single bond or a linking group; Q³¹ to Q³⁵ represent an atom group coordinated to M³¹; Y³¹ represents a linking group; n³¹ represents 0 or 1; if n³¹ is 0, there is no bond between Q³² and Q³³ via X³³; M³¹ represents a bivalent platinum ion or a bivalent palladium ion.

4. The organic electroluminescent device according to claim 2, wherein the hexadentate metal complex having the hexadentate ligand is a compound represented by the following formula (4), formula (5), or formula (6): 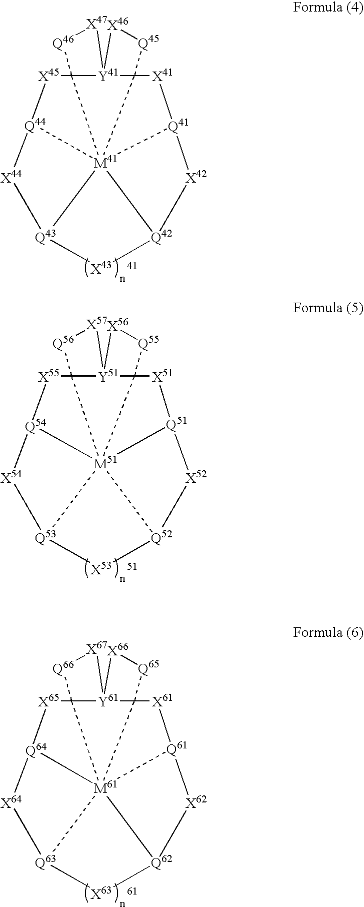
wherein in the formula (4), X⁴¹ to X⁴⁷ independently represent a single bond or a linking group; Q⁴¹ to Q⁴⁶ represent an atom group coordinated to M⁴¹; Y⁴¹ represents a carbon atom or a silicon atom; n⁴¹ represents 0 or 1; if n⁴¹ is 0, there is no bond between Q⁴² and Q⁴³ via X⁴³; M⁴¹ represents a bivalent platinum ion or a bivalent palladium ion;
wherein in the formula (5), X⁵¹ to X⁵⁷ independently represent a single bond or a linking group; Q⁵¹ to Q⁵⁶ represent an atom group coordinated to M⁵¹; Y⁵¹ represents a carbon atom or a silicon atom; n⁵¹ represents 0 or 1; if n⁵¹ is 0, there is no bond between Q⁵² and Q⁵³ via X⁵³; M⁵¹ represents a bivalent platinum ion or a bivalent palladium ion;
wherein in the formula (6), X⁶¹ to X⁶⁷ independently represent a single bond or a linking group; Q⁶¹ to Q⁶⁶ represent an atom group coordinated to M⁶¹; Y⁶¹ represents a carbon atom or a silicon atom; n⁶¹ represents 0 or 1; if n⁶¹ is 0, there is no bond between Q⁶² and Q⁶³ via X⁶³; M⁶¹ represents a bivalent platinum ion or a bivalent palladium ion.

5. The organic electroluminescent device according to claim 2, wherein the pentadentate metal complex having the pentadentate ligand is a compound represented by the following formula (7): 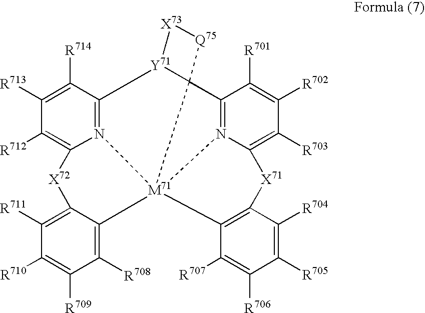
wherein in the formula (7), X⁷¹ to X⁷³ independently represent a single bond or a linking group; Q⁷⁵ represents an atom group coordinated to M⁷¹; Y⁷¹ represents a linking group; R⁷⁰¹ to R⁷¹⁴ independently represent a hydrogen atom or a substituent; R⁷⁰⁷ and R⁷⁰⁸ may be bonded; M⁷¹ represents a bivalent platinum ion or a bivalent palladium ion.

6. The organic electroluminescent device according to claim 2, wherein the hexadentate metal complex having the hexadentate ligand is a compound represented by the following formula (8): 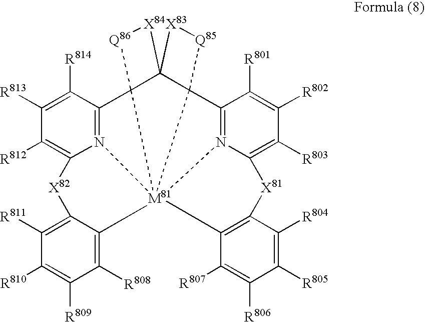
wherein in the formula (8), X⁸¹ to X⁸⁴ independently represent a single bond or a linking group; Q⁸⁵ and Q⁸⁶ represent an atom group coordinated to M⁸¹; R⁸⁰¹ to R⁸¹⁴ independently represent a hydrogen atom or a substituent; R⁸⁰⁷ and R⁸⁰⁸ may be bonded; M⁸¹ represents a bivalent platinum ion or a bivalent palladium ion.

7. The organic electroluminescent device according to claim 1, wherein the pentadentate or hexadentate metal complex is a phosphorescence material.

8. The organic electroluminescent device according to claim 2, wherein the pentadentate or hexadentate metal complex is a phosphorescence material.

9. The organic electroluminescent device according to claim 3, wherein the pentadentate or hexadentate metal complex is a phosphorescence material.

10. The organic electroluminescent device according to claim 4, wherein the pentadentate or hexadentate metal complex is a phosphorescence material.

11. The organic electroluminescent device according to claim 5, wherein the pentadentate or hexadentate metal complex is a phosphorescence material.

12. The organic electroluminescent device according to claim 6, wherein the pentadentate or hexadentate metal complex is a phosphorescence material.

13. The organic electroluminescent device according to claim 1, wherein the thickness of the luminescent layer is 5 nm to 1 μm.

14. The organic electroluminescent device according to claim 1, wherein the luminescent layer is a laminated structure having 4 layers or more but 30 layers or less.

15. The organic electroluminescent device according to claim 1, wherein the thickness of the respective layers constituting the laminated structure is 0.2 nm or more but 20 nm or less.

16. A multi color luminescent device comprising a blue luminescent device containing a blue fluorescence compound and the organic electroluminescent device according to claim 1.
